(19) United States
(12) Patent Application Publication
(10) Pub. No.: US 2006/0221024 A1
(43) Pub. Date: Oct. 5, 2006

(54) Pixel shift device and display apparatus

(75) Inventors: Aira Hotta, Tokyo (JP); Haruhiko Okumura, Kanagawa-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KABUSHIKI KAISHA TOSHIBA

(21) Appl. No.: 11/393,826

(22) Filed: Mar. 31, 2006

(30) Foreign Application Priority Data
Mar. 31, 2005 (JP) P2005-103816

(51) Int. Cl. G09G 3/36

(52) U.S. Cl. 345/87

(57) ABSTRACT

A pixel shift device has at least one liquid crystal structure. In the liquid crystal structure, a pair of transparent electrodes is located facing each other. A pair of alignment films is between the pair of transparent electrodes. Each of the pair of alignment films has mutually anti-parallel alignment direction. A nematic liquid crystal layer is within the pair of alignment films.

### CROSS-REFERENCE TO RELATED APPLICATIONS

This application is based upon and claims the benefit of priority from prior Japanese Patent Application No. 2005-103816, filed on Mar. 31, 2005; the entire contents of which are incorporated herein by reference.

### FIELD OF THE INVENTION

The present invention relates to a pixel shift device and display apparatus for shifting an optical axis of an incident light.

### BACKGROUND OF THE INVENTION

In a display apparatus, high resolution of a display image is increasingly desired. As a method for high resolution, small size of a pixel to be displayed on the display apparatus is considered. Furthermore, high resolution of the display apparatus is proposed by a pixel shift device. The pixel shift device is mounted onto a front face of the display apparatus, and an optical axis of an outgoing light from the display apparatus is periodically shifted. By periodically shifting the optical axis, a pixel can be apparently located between original pixels and a high quality image with high resolution can be presented.

As prior art, in Japanese Patent Disclosure (Kokai) H7-64048 (reference 1) and Japanese Patent Disclosure (Kokai) 2004-272170 (reference 2), the pixel shift device having a liquid crystal device to control a polarized direction and a birefringent plate to change an advance direction of light is disclosed. Furthermore, in Japanese Patent Disclosure (Kokai) H11-298829 (reference 3), a pixel shift device using a flat plate prism is disclosed. Furthermore, in “The 11th International Display Workshops (IDW' 04) pp 1663-1667, 2004” (reference 4), a pixel shift device using a vertical aligned ferroelectric liquid crystal is disclosed.

However, in the pixel shift device of the references 1 and 2, a birefringent plate such as a crystal or a LiNbO3 crystal is necessary. Accordingly, the pixel shift device is expensive. Furthermore, in the pixel shift device of the reference 3, the flat plate prism is obliquely inserted into the display apparatus and rotated at high speed. Accordingly, miniaturization of the display apparatus is difficult. Furthermore, in the pixel shift device of the reference 4, alignment control of ferroelectric liquid crystal is difficult and mis-alignment of the crystal often occurs. Accordingly, the pixel shift device stable for a long time cannot be obtained.

### SUMMARY OF THE INVENTION

The present invention is directed to a pixel shift device and display apparatus of simple component with high reliability.

According to an aspect of the present invention, there is provided a pixel shift device having a liquid crystal structure comprising: a pair of transparent electrodes located facing each other; a pair of alignment films each located facing each other on each of the pair of transparent electrodes, each of the pair of alignment films mutually having anti-parallel alignment direction; and a nematic liquid crystal layer located within the pair of alignment films.

According to another aspect of the present invention, there is also provided a display apparatus comprising: a display device displaying an image; a polarization unit configured to supply a polarization of predetermined direction to a light outgoing from the display device; and a pixel shift device shifting an optical axis of a polarized light outgoing from the polarization unit. The pixel shift device comprises a pair of transparent electrodes located facing each other; a pair of alignment films located facing each other on each of the pair of transparent electrodes, each of the pair of alignment films mutually having anti-parallel alignment direction perpendicular to a polarized direction of the polarized light; and a nematic liquid crystal layer located within the pair of alignment films.

### BRIEF DESCRIPTION OF THE DRAWINGS

FIG. 1 is a sectional view of a pixel shift device according to a first embodiment of the present invention.

FIGS. 2A, 2B and 2C are schematic diagrams showing activation principle of the pixel shift device.

FIG. 3 is a graph showing relationship between angle θ of a liquid crystal director and shift quantity d of a liquid crystal layer.

FIG. 4 is a graph showing a response characteristic of the pixel shift device.

FIG. 5 is a block diagram of an experimental apparatus for obtaining the results of FIG. 4.

FIG. 6 is a table showing a relationship between a shift quantity and a response time in case of changing a low limit value of a liquid crystal director angle θ.

FIG. 7 is a graph showing a voltage waveform applied to the pixel shift device in case of changing the liquid crystal director angle θ from a high limit value θ2 to a low limit value θ1.

FIG. 8 is a schematic diagram of a display apparatus according to a second embodiment of the present invention.

FIG. 9 is a timing chart showing a switch timing between a display device and the pixel shift device.

FIGS. 10A, 10B and 10C are schematic diagrams showing the display status of a moving picture.

FIG. 11 is a schematic diagram of the display apparatus according to a modification of the second embodiment of the present invention.

### DETAILED DESCRIPTION OF THE EMBODIMENTS

Hereinafter, various embodiments of the present invention will be explained by referring to the drawings. The present invention is not limited to the following embodiments.

### The First Embodiment

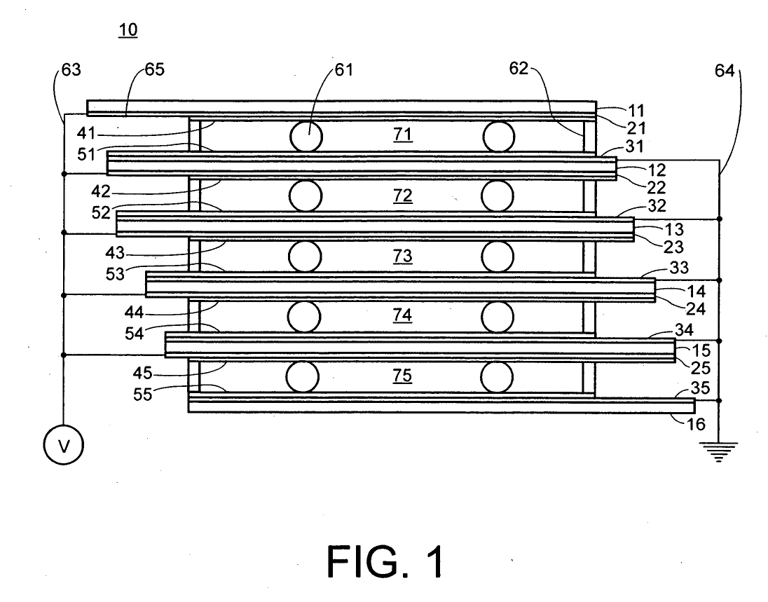

FIG. 1 is a sectional view of a pixel shift device 10 according to the first embodiment of the present invention. The pixel shift device 10 includes transparent substrates 11˜16, transparent conductive films (transparent electrodes) 21˜25, 31˜35, alignment films 41˜45, 51˜55, spacers 61, seal materials 62, an external signal input unit 63 and 64, and liquid crystal layers 71˜75.

The transparent substrates 11˜16 are composed by an optical transparent material such as a glass plate. An optical transparent material except for the glass plate, for example, a plastic film, can be used for the transparent substrates 11˜16. The transparent substrate 11 of the upper layer and the transparent substrate 16 of the lower layer preferably have enough thickness to maintain the shape of the pixel shift device 10 against the outside. On the other hand, the transparent substrates 12˜15 may be thinner than the transparent substrates 11 and 16 because of laminated inside the pixel shift device.

The transparent conductive films 21 and 35 are respectively formed on one side of the transparent substrates 11 and 16. The transparent conductive films 31˜34 and 22˜25 are respectively formed on both sides of the transparent substrates 12˜15. The alignment films 41˜45 and 51˜55 such as alignment-processed polyimide are respectively located on a surface of the transparent conductive films 21˜25 and 31˜35. The transparent conductive films 21 and 35 and the alignment films 41 and 55 are thus respectively located on one side of the transparent substrates 11 and 16. The transparent conductive films 31˜34 and 22˜25 and the alignment films 51˜55 and 42˜45 are respectively located on both sides of the transparent substrates 12˜15. The alignment films 51˜55 and the alignment films 41˜45 are respectively located facing each other so that the alignment directions are mutually anti-parallel.

For example, the transparent substrates 11˜16 are located with facing while keeping a predetermined gap by the spacer 61 having several μm diameter. By injecting a liquid crystal material between the transparent substrates 11˜16, the liquid crystal layers 71˜75 are formed, and sealed by a sealing material 62 coated with epoxide. As mentioned-above, the alignment films 51˜55 and the alignment films 41˜45 are respectively located facing each other so that each alignment direction of two facing alignment films are mutually anti-parallel. Accordingly, the liquid crystal material injected has parallel alignment.

As the spacer 61, various shapes such as a sphere or a pillar can be used. If a space between the transparents 11˜16 is kept, the spacer 61 of any shape can be used. Furthermore, without the spacer 61 located on the center of the transparent substrates 11˜16, a space between the transparent substrates 11˜16 can be kept by a spacer attached to the sealing material 62.

The external signal input units 63 and 64 are respectively electric wirings connected to the transparent conductive films 21˜25 and 31˜35, and used to apply a driving signal to the liquid crystal layers 71˜75. The external signal input units 63 and 64 can be connected to the transparent conductive films 21˜25 and 31˜35 by an electrode extraction unit 65. The electrode extraction unit 65 is suitably located on a projection area (For example, four sides of the transparent substrates 11˜16) of the transparent conductive films 21˜25 and 31˜35 from the facing substrates 11˜16 by mutually shifting the transparent substrates 11˜16. Furthermore, irrespective of applying voltage (driving signal) to the liquid crystal layers 71˜75 by the external signal input units 63 and 64, the driving signal may be respectively input to the liquid crystal layers 71˜75.

The liquid crystal layers 71˜75 are respectively aligned by the alignment films 41˜45 and 51˜55 facing each other, and applied with voltage by the transparent conductive films 21˜25 and 31˜35. The liquid crystal layers 71˜75, the alignment films 41˜45 and 51˜55 facing each other, and the transparent conductive films 21˜25 and 31˜35 facing each other form a plurality of liquid crystal structures with lamination. For example, the liquid crystal layer 71, the alignment films 41 and 51 facing each other, and the transparent conductive films 21 and 31 facing each other, form one liquid crystal structure. In the first embodiment, the pixel shift device 10 includes five layers of liquid crystal structures of five layers (five liquid crystal structures 71˜75). However, the number of layers is not limited to five, and can be suitably varied such as below four or above six.

As explained afterwards, in the liquid crystal structure, an optical axis of an incident light can be shifted. By laminating a plurality of liquid crystal structures together, a shift quantity of the incident light increases. Also, by building the optical shift device 10 with a plurality of liquid crystal layers, the operation speed rises.

A. Operation Principle of Pixel Shift Device 10

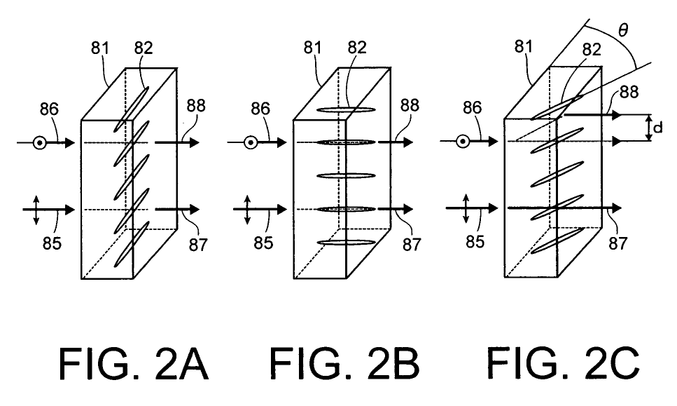

Next, the operation principle of the pixel shift device 10 is explained. FIG. 2 is a schematic diagram of the operation principle of the pixel shift device 10. FIG. 2A shows non-applying status (applied voltage is below a threshold) of voltage to the liquid crystal layer 81. FIG. 2B shows applying status of sufficient large voltage (applied voltage is above the threshold) to the liquid crystal layer 81. FIG. 8C shows applying status of a middle voltage (applied voltage is above the threshold and below a saturation voltage) to the liquid crystal layer 81.

By applying a driving signal to the liquid crystal layer 81 parallel-aligned by the alignment films (two facing alignment directions are mutually anti-parallel), angle θ of the liquid crystal director 82 to a face of the liquid crystal layer 81 (main face of the basic substrate) changes. In this case, the liquid crystal director 82 corresponds to a vector as a direction of liquid crystal molecule at the center of the liquid crystal layer 81. The liquid crystal layer 81 may be each or all of the liquid crystal layers 71˜75 of the pixel shift device 10. In both cases, an optical axis of incident light can be shifted.

In FIG. 2A, the liquid crystal director 82 is parallel to a face (basic face) of the liquid crystal layer 81 (angle θ of the liquid crystal director 82 is 0°). In FIG. 2B, a liquid crystal is directed to a layer direction by applied voltage along the layer direction, and the liquid crystal director 82 is perpendicular to the face of the liquid crystal layer 81 (θ=90°). In FIG. 2C, the liquid crystal director 82 is inclined to the face of the liquid crystal layer 81 (0°<θ<90°).

Lights 85 and 86 are incident to the liquid crystal layer 81, passing and outgoing as lights 87 and 88. The incident light 85 is a polarized light along top and bottom direction on this paper, and the incident light 86 is a polarized light along a perpendicular direction on this paper. The outgoing lights 87 and 88 respectively correspond to the incident lights 85 and 86.

As shown in FIGS. 2A and 2B, if the liquid crystal director 82 is parallel to (θ=0°) or perpendicular to (θ=90°) the liquid crystal layer 81, the incident lights 85 and 86 respectively go straight. On the other hand, as shown in FIG. 2C, if the liquid crystal director 82 is inclined to the liquid crystal layer 81, the incident light 85 goes straight. However, the incident light 86 are obliquely going along an optical axis of the liquid crystal, and outgoing from a position shifted as a distance d from an original outgoing position. In this case, the optical axis is an optical anisotropy axis (Usually, one axis of anisotropy) and corresponds to the liquid crystal director 82. Briefly, the optical axis (optical path) of the incident light 86 is shifted as the distance d.

The reason why the incident light 86 is only shifted is that the incident light 86 corresponds to an extraordinary light from the optical axis of the liquid crystal. The reason why the incident light 85 is not shifted is that the incident light 85 corresponds to an ordinary light from the optical axis of the liquid crystal. Concretely, a polarized direction of the incident light 85 (ordinary light) is perpendicular to the optical axis of the liquid crystal. Accordingly, the polarized direction of the incident light 85 is affected by a refractive index nₒ perpendicular to the optical axis, and not affected by a refractive index nₑ parallel to the optical axis of the liquid crystal. Briefly, an optical path of the ordinary light is not changed by inclination of the liquid crystal director 82. On the other hand, a polarized direction of the incident light 86 (extraordinary light) has an element parallel to the optical axis. Accordingly, the polarized direction of the incident light 86 is affected by the refractive index nₒ perpendicular to the optical axis and the refractive index nₑ parallel to the optical axis. Briefly, an optical path of the extraordinary light is changed because angle of refraction is different based on inclination of the liquid crystal director 82.

In this way, by controlling the optical axis (the liquid crystal director 82) with voltage, an optical path of the extraordinary light (incident light 86 having a polarized direction parallel to alignment direction of the liquid crystal layer 81) incident to the pixel shift device 10 can be controlled.

B. Characteristic of Pixel Shift Device 10

A shift quantity d of the pixel shift device 10 depends on a thickness t of the liquid crystal layer 81, an angle θ between the liquid crystal director 82 and the liquid crystal layer (substrate surface), a refractive index nₑ and nₒ of the liquid crystal material, and a voltage of the driving signal.

(1) Effect of the Number of Layers of Liquid Crystal Layer

Effect of the number of layers of the liquid crystal layer 81 for the pixel shift device 10 is explained. If the thickness t of the liquid crystal layer is thick, the shift quantity d of optical path becomes large. Accordingly, in order to enlarge the shift quantity d to some extent, the thickness t of the liquid crystal layer is desirably thick. However, when the thickness t of the liquid crystal layer 81 is thick, the response speed of the pixel shift device 10 is slow. For example, if the thickness t of the liquid crystal layer 81 is extremely thick in comparison with a normal thickness of TN liquid crystal of a liquid crystal display apparatus, the pixel shift device 10 probably cannot follow display change of the liquid crystal display apparatus.

In the first embodiment, in order for the shift quantity d to be consistent with the response speed, a plurality of liquid crystal layers 71˜75 are laminated together. As a result, the response speed is maintained while the thickness t per one layer is thin, and the shift quantity d of optical path is maintained while the thickness T (=N·t, N: the number of layers of the liquid crystal layer) is thick. Briefly, the thickness of the liquid crystal layer 81 is determined by relationship between the shift quantity and the response speed. The thickness t per one layer is calculated to obtain necessary speed, and liquid crystal layers are laminated to the thickness T of all the liquid crystal layers to obtain necessary shift quantity.

(2) Respective Driving of Liquid Crystal Layer

Above explanation is on the assumption that signal is simultaneously applied to the liquid crystal layers 71˜75 of the pixel shift device 10. On the other hand, the liquid crystal layers 71˜75 can be separately driven. In this case, by separately shift-controlling the liquid crystal layers 71˜75, the shift quantity can be gradually controlled.

As explained afterwards, a first voltage corresponds to a first angle (For example, 50°) of the liquid crystal director 82, and a second voltage corresponds to a second angle (For example, 90°) of the liquid crystal director 82. By applying driving signals of the first voltage and the second voltage to the liquid crystal layer 81, the pixel shift device 10 is driven.

Assume that the shift quantity d of each liquid crystal layer 71˜75 is d₀ at the first voltage and 0 at the second voltage. The shift quantity D of the total pixel shift device 10 can be changed from 0 to 5·d₀ by a step d₀. Furthermore, by differentiating the shift quantity d of each liquid crystal layer 71˜75 (For example, thickness of each liquid crystal layer is different), the shift quantity D of the total pixel shift device 10 can be finely controlled.

Control of the shift quantity is on the assumption that each liquid crystal layer 71˜75 is binary-controlled. Of course, the shift quantity can be gradually controlled by gradually applying voltage to each liquid crystal layer. However, graduate control of applied voltage may cause fall of the response speed of the pixel shift device 10 because the response speed depends on the applied voltage. On the other hand, the shift quantity is gradually controlled by combination of binary-control of each liquid crystal layer 71˜75. In this case, dependency of the response speed with the shift quantity can be reduced. Application example of control of the shift quantity is explained afterwards.

(3) Effect of Liquid Crystal Material Composing Liquid Crystal Layer

Next, the effect of a liquid crystal material composing the liquid crystal layer for characteristic of the pixel shift device 10 is explained. If a birefringence Δn (=nₑ−nₒ) is large, the shift quantity d of optical path is also large. Accordingly, in order for the shift quantity d to enlarge to some extent, it is desired that the birefringence Δn is large to some extent (For example, Δn≧0.2). The birefringence Δn is measured by a method described in “Liquid Crystal (basic chapter), published by Baifukan in July of 1985, edited by Mitsuharu Okano and Syunsuke Kobayashi, pp 213˜”.

Next, viscosity of the liquid crystal material is explained. In case of changing the angle θ of the liquid crystal director from 50° to 90°, a voltage above the saturation voltage is applied to the liquid crystal layer 81. In this case, the higher the voltage applied to the liquid crystal layer 81 is, the quicker the response speed is. On the other hand, in case of returning the angle θ from 90° to 50°, the response speed depends on a viscosity parameter and an elastic constant of the liquid crystal material, and a thickness of the liquid crystal layer 81. Accordingly, in order to raise the response speed, it is desired that the thickness of the liquid crystal layer 81 is thin and the viscosity parameter of the liquid crystal is small. For example, the viscosity parameter γ1 of the liquid crystal material is desirably below 200 mPa·s. The viscosity parameter γ1 is measured by a method described in above-mentioned reference “Liquid Crystal (basic chapter), pp 220˜”.

(4) Effect of Angle Limit of Liquid Crystal Director

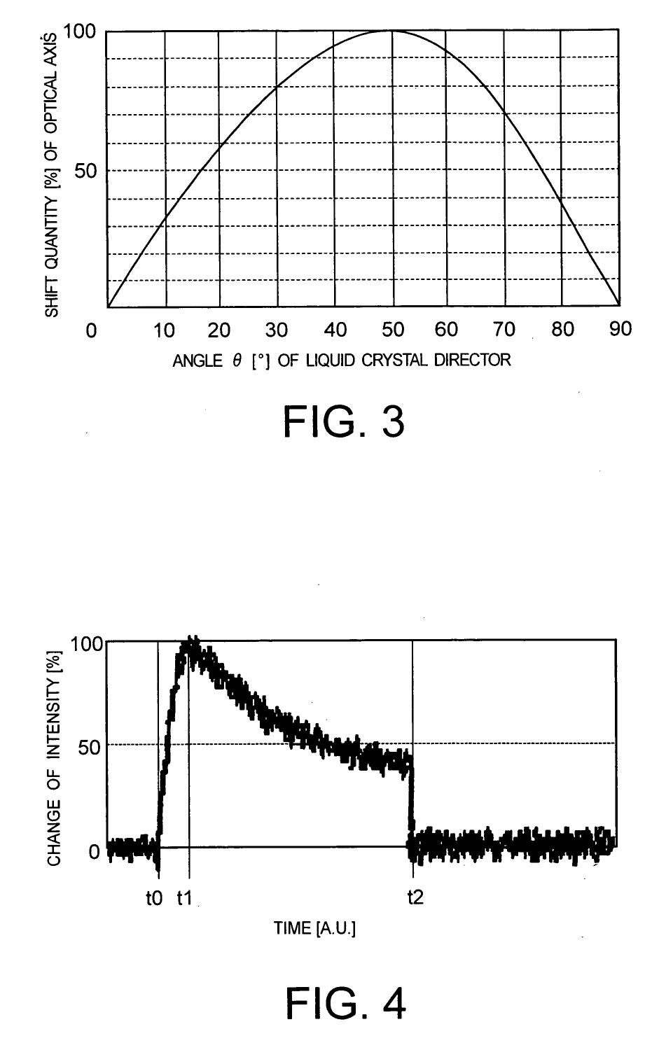

Next, the effect of angle limit of the liquid crystal director for the pixel shift device 10 is explained. FIG. 3 shows a graph representing a relationship of an angle θ between the liquid crystal director 82 and the liquid crystal layer 81 (substrate surface), and a shift quantity d. In this case, as a liquid crystal material, general nematic liquid crystal layer is used, and a relationship between the angle θ and the shift quantity d is guided by simulation. Briefly, alignment distribution of the liquid crystal layer 81 based on applied voltage is calculated by electric/dynamic simulation, and the shift quantity of light passing through the liquid crystal layer 81 is calculated by optical simulation.

As shown in FIG. 3, when the angle θ of the liquid crystal director is 50° slightly above 45°, the shift quantity d represents the maximum. When the angle is 0° and 90°, the shift quantity d represents 0. Briefly, by operating the pixel shift device 10 within the angle limit “0°˜50°” or “50°˜90°”, the shift quantity d based on the angle θ of the liquid crystal director is obtained. In this case, change of the shift quantity d represents the maximum.

In the pixel shift device 10, response characteristic of angle limit “50°˜90°” is more profitable than angle limit “0°˜50°”. By operating the liquid crystal director in the angle θ above 50°, the thickness of one liquid crystal layer increases and the number of laminated layers decreases. Because applied driving voltage in angle limit “50°˜90°” is larger than in angle limit “0°˜50°” (When the applied voltage is large, the response speed becomes quick).

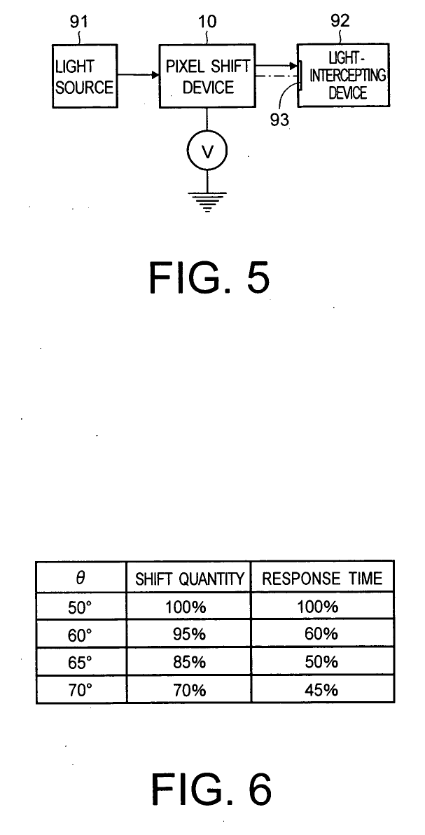

FIG. 4 shows one example of graph of response characteristic of the pixel shift device 10. In this graph, the horizontal axis represents time and the vertical axis represents change of intensity. As shown in FIG. 5, an optical path of light beam outgoing from a light source 91 is shifted by the pixel shift device 10, and change of intensity (change of light quantity incident to a light-intercepting face 93) is measured by a light-intercepting device 92. The change of intensity along the vertical axis corresponds to change of the shift quantity d of the pixel shift device 10. In a time limit before t0 and a time limit after t2 of FIG. 4, the second voltage above the saturation voltage is applied to the pixel shift device 10 (voltage ON). On the other hand, in a time limit “t0˜t2”, voltage is not applied to the pixel shift device 10 (voltage OFF).

As shown in the relationship of FIG. 3, angle θ of the liquid crystal director 82 is 90° in time limit below t0 of FIG. 4. By setting the voltage OFF at time t0, angle θ of the liquid crystal director 82 is reduced from 90° to 0°. In this case, intensity increases in time limit “t0˜t1”, is the maximum at time t1, and decreases after t1. At time t1 when the intensity is the maximum, the shift quantity is also the maximum. As shown in the relationship of FIG. 3, angle θ of the liquid crystal director 82 is approximately 50°. Briefly, angle θ of the liquid crystal director is 90° at time t0 and 50° at time t1.

The angle θ of the liquid crystal director 82 decreases from 50° to 0° during time limit “t1˜t2”, but does not reach 0° at time t2 (At time t2, the intensity is larger than at time t0). The change of intensity at time t2 is approximately 40%. If the change of intensity is in proportion to the shift quantity d, angle θ of the liquid crystal director at time t2 is approximately 13°.

A response time T1 in which the angle θ of the liquid crystal director 82 changes from 90° to 50° is represented as (t1-t0) in FIG. 4. On the other hand, a response time T2 in which the angle θ changes from 50° to 13° is represented as (t2-t1) in FIG. 4. Briefly, in case that the voltage applied to the liquid crystal layer is OFF, a time in which the angle θ of the liquid crystal director changes from 90° to 50° is smaller than a time in which the angle θ changes from 50° to 0°.

By narrowing change limit of angle θ of the liquid crystal director 82 than “50°˜90°”, the response speed rises. Briefly, a lower limit of the angle θ is set above 50°. In this case, the response time of the pixel shift device 10 is reduced. For example, the response time is 50% of the time T1 in which the angle θ of the liquid crystal director 82 changes from 90° to 50°. However, the shift quantity d becomes small.

FIG. 6 is a table of relationship between the shift quantity and the response time in case that angle θ of the lower limit of the liquid crystal director changes. The change of the shift quantity is small in the angle θ below 65° while the change of the shift quantity is large in the angle θ above 65°. Accordingly, increase of the angle from 50° to 65° is effective for the shift quantity and the response time to be consistent.

(5) Effect of Driving Signal

By controlling a voltage waveform applied to the pixel shift device 10, the response time of the pixel shift device 10 is executed at high speed. For example, a waveform to be applied to the pixel shift device 10 is a square wave (30˜120 Hz). Accordingly, angle θ of the liquid crystal director is switched by a lower limit θ1 (For example, 50°˜65°) and an upper limit θ2 (For example, 90°). In case of switching, a voltage Vθ1 corresponding to the lower limit θ1 and a voltage Vθ2 corresponding to the upper limit θ2 are selectively applied to the pixel shift device 10. The voltage Vθ1 is the applied voltage in case of “θ=θ1”, for example, a middle voltage between a threshold voltage and a saturation voltage. The voltage Vθ2 is the applied voltage in case of “θ=θ2”, for example, a voltage above the saturation voltage. Briefly, by setting the angle θ of the liquid crystal director as the lower limit θ1 or the upper limit θ2, the voltage Vθ1 or Vθ2 is selectively applied to the pixel shift device 10.

In case of changing the angle θ of the liquid crystal director from the upper limit θ2 to the lower limit θ1, the voltage is simply switched from Vθ2 to Vθ1. However, if a voltage of which absolute value is below the voltage θ1 is inserted into voltage change from Vθ2 to Vθ1, the response speed rises. For example, by inserting 0V, the response speed rises as 10˜20%.

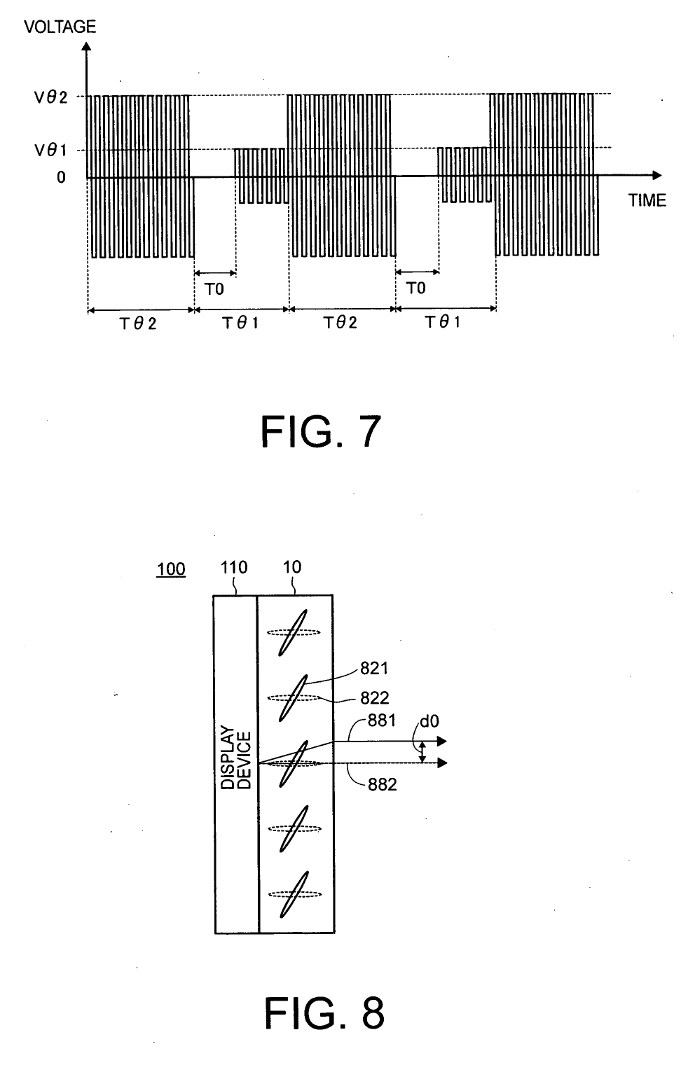

FIG. 7 is a graph of voltage waveform applied to the pixel shift device 10 in case of changing the angle θ of the liquid crystal director from the upper limit θ2 to the lower limit θ1. A square wave of voltage Vθ2 by which the angle θ is the upper limit θ2 is applied in time Tθ2. Then, a square wave of voltage Vθ1 by which the angle θ is the lower limit θ1 is applied in a predetermined time via non-applying time T0, and time Tθ1 passes on the whole. If a response time in which the angle θ returns from the upper limit θ2 to the lower limit θ1 is τoff, non-applying time T0 (period to insert 0V) is defined as following limit (1).
0.1×τoff≦T0≦τoff (1)

The non-applying time T0 of voltage is set based on the above limit (1), because if the non-applying time T0 is too short compared with the response time τoff, the response time does not almost rise. Furthermore, if the non-applying time T0 is equal to or above the response time τoff, substantial response time rather falls.

### The Second Embodiment

Next, a second embodiment of the present invention is explained. FIG. 8 is a schematic diagram of a display apparatus 100 of the second embodiment. The display apparatus 100 include a display device 110 and a pixel shift device 10. The display device 110 displays an image by dot-accumulation such as a liquid crystal display device, a plasma display device, or a CRT. The pixel shift device 10 is mounted to a front face of the display device 110.

Shift quantity of outgoing lights 881 and 882 from the display device 110 is changed by driving the liquid crystal directors 821 and 822. Briefly, a predetermined voltage is applied to the pixel shift device 10, and the liquid crystal director 821 is inclined to a main face of the pixel shift device. In this case, an optical path of light incident to the pixel shift device 10 is shifted to a direction of the liquid crystal director 821. In case that angle of the liquid crystal director 822 is 90° from the main face, the optical path goes straight without shift.

(1) Polarization Means

Light incident from the display device 110 to the pixel shift device 10 should be a polarized light vibrating in a predetermined direction. If the display device 110 does not have a polarization means, a polarizer is located between the display device 110 and the pixel shift device 10. Furthermore, the pixel shift device 10 is located so that a polarized direction of the polarizer is perpendicular to an alignment direction of the liquid crystal of the pixel shift device 10. In case that the display device 110 is a liquid crystal display device, outgoing light will be polarized light. Accordingly, a polarization means is not usually necessary. However, in case that a polarized direction of the liquid crystal display device does not correspond to an alignment direction of the liquid crystal of the pixel shift device, a means for corresponding the polarized direction with the alignment direction (For example, a device to rotate the polarized direction) is necessary.

(2) Synchronization with Image Signal

By driving the pixel shift device 10 in synchronization with an image signal of the display device 110, resolution of the display apparatus rises. For example, if the display device 110 is interlace-driven, the resolution same as progressive-driven is obtained. Briefly, pixel of which optical path is shifted by the pixel shift device 10 is located between original pixels of which optical path is not shifted by the pixel shift device 10. In this case, resolution apparently rises.

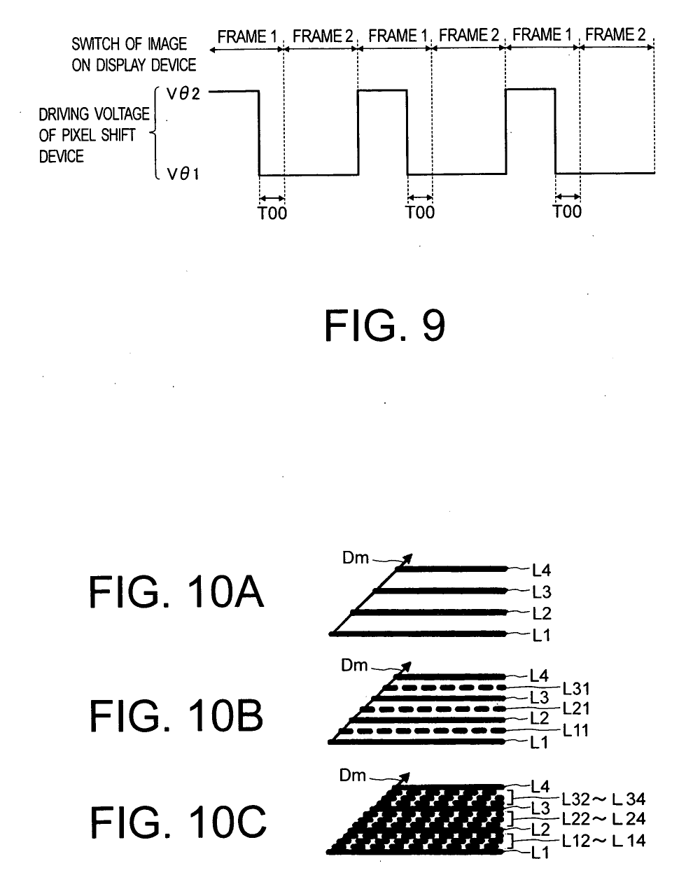

FIG. 9 is a timing chart representing a switch timing of the display device 110 and the pixel shift device 10. In the display device 110, a frame 1 and a frame 2 are mutually switched and displayed. The pixel shift device 10 does not shift the frame 1 (angle θ of the liquid crystal director is the maximum θ2, for example, 90°) and shifts the frame 2 (angle θ of the liquid crystal director is the minimum θ1, for example, 50°). Accordingly, a voltage Vθ2 corresponding to the frame 1 is applied to the pixel shift device 10, and a voltage Vθ1 corresponding to the frame 2 is applied to the pixel shift device 10.

The voltage Vθ2 is applied to the pixel shift device 10 at almost the same time as the start timing of the frame 1. On the other hand, the voltage Vθ1 is applied to the pixel shift device 10 by preceding time T00 from start timing of the frame 2. A response speed of the pixel shift device 10 is quick during raising the voltage and slower during lowering the voltage. Accordingly, when the voltage is changed at the same time as start timing of a display signal, the response time varies by an image to be shifted and an image not to be shifted. In this case, the voltage is desirably applied by shifting the timing as a half of the response time of the pixel shift device 10. As a result, a time change of the image shifted is equal to a time change of the image not shifted, and a better image can be obtained. The response speed τ corresponds to a time from change timing of applied voltage to the pixel shift device 10 (from Vθ1 to Vθ2 or from Vθ2 to Vθ1) to moving timing of incident light to a predetermined shift position.

(3) Gradual Control of Shift Quantity

In the first embodiment, gradual control of shift quantity by driving the liquid crystal layers was explained. For example, the gradual control of shift quantity can be utilized to prevent interlace lines. In case of a dynamic picture, due to eye's track movement for motion of the picture, the resolution may fall by recognizing the interlace line (missing of line shape). In this case, by gradually changing the shift quantity of the pixel shift device 10 based on motion of dynamic picture, the interlace line can be hard to see.

FIGS. 10A, 10B, and 10C are schematic diagrams of the display status of an image changing with the passage of time (dynamic picture). FIGS. 10A, 10B, and 10C respectively correspond to the case of non-shift, the case of binary shift, and the case of gradual shift (by multi-value) by the pixel shift device 10. This image includes motion along a direction Dm. Briefly, a line L1 displayed at time t1 is moved to lines L2˜L4 with passage of time t2˜t4. Furthermore, in FIGS. 10B and 10C, as a result of shift of optical axis by the pixel shift device 10, one line (L11˜L31) and three lines (L12˜L14, L22˜L24, L32˜L34) are respectively inserted between Lines L1˜L4. In FIG. 10C, the optical axis is shifted between two lines by three steps (If non-shift step is included, four steps). The number of steps can be suitably determined based on the case.

In FIG. 10A, interlace line (missing of line shape) is recognized between lines L1˜L4. On the other hand, in FIGS. 10B and 10C, occurrence of interlace line is reduced by shifting the optical axis (pixels) using the pixel shift device 10. In case that motion of image is quick, user eye's track movement is also quick and the user often views the interlace line. Accordingly, a video having quick motion is not shifted by binary (FIG. 10B) but shifted gradually (FIG. 10C). As a result, the interlace line (missing of line shape) is hard to see and the resolution of the video rises.

### Modification of the Second Embodiment

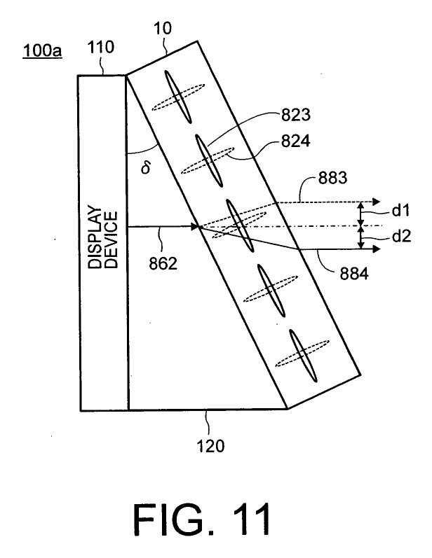

FIG. 11 is a schematic diagram of a display apparatus 100a according to a modification of the second embodiment. The display apparatus 100a is composed by combining the display device 110 with the pixel shift device 10. The pixel shift device 10 is obliquely (angle δ) located to the display device 110, and a triangle prism 120 is located between the pixel shift device 10 and the display device 110. The triangle prism 120 is set to fix the pixel shift device 10 (set of angle δ). Furthermore, by optically sticking a space among the triangle prism 120, the pixel shift device 10 and the display device 110, or by coating the space with matching oil, reflection from the space can be reduced.

An outgoing light 862 from the display device 110 is obliquely incident to the pixel shift device 10 as angle δ. In this case, pixel shifts d1 and d2 are occurred in a liquid crystal director 823 (angle θ=0°) and a liquid crystal director 824 (angle θ=90°). Shift directions of the pixel shifts d1 and d2 are the opposite.

In case of a straight incident light, even if angle θ of the liquid crystal director is changed in a limit “0°˜90°”, a shift quantity is the maximum when the angle θ is approximately 50°, and decreases at other angles. On the other hand, in case of an oblique incident light, the shift quantity monotonously changes (increases or decreases) in the limit “0°˜90°”, and a wider limit as the angle θ of the liquid crystal director can be used. Briefly, because operation angle of the liquid crystal director is enlarged, a thickness of the liquid crystal layer can be reduced. For example, if angle δ of the pixel shift device 10 is within the limit “40°˜50°”, in comparison with horizontal location to the display apparatus, double shift quantity can be obtained.

Hereinafter, various methods for manufacturing and testing the pixel shift device of the present invention are explained.

(Method 1)

Two glass substrates (diagonal: 75 mm (3 inch), thickness: 0.7 mm) are prepared. On one surface of each glass substrate, a thin film (thickness: 50 nm) of ITO (Indium Tin Oxide) is formed. Furthermore, eight glass substrates (diagonal: 75 mm, thickness: 0.5 mm) are prepared. On both surface of each glass substrate, the thin film of ITO is formed. After washing these ten substrates, polyimide AL1051 for liquid crystal alignment film is coated using spin coat. Then, by baking these substrates in a clean oven at almost 200° C. for one hour, polyimide films (thickness: 50˜100 nm) are coated on both surface of each substrate.

Next, alignment processing by rubbing is executed. As for each substrate coated with the polyimide film on both surfaces, after rubbing on one surface, a circumference of the rubbing surface is protected by a frame and the other surface is rubbed. By this rubbing, a liquid crystal alignment is provided for the polyimide film (alignment film is formed on both surfaces).

Next, as for two substrates each of which has one surface is alignment-processed, an epoxy sealing material (Stractbond manufactured by Mitsui Chemical Inc.) is coated on by a seal dispenser. As for one substrate of which both surfaces are alignment-processed, Micropearl (manufactured by Sekisui Chemical Inc.) of 4.5 μm as a spacer is dispersed on one surface while the other surface is protected. By assembling the one substrate with one of the two substrates, a cell to form a first liquid crystal layer is obtained.

Next, the epoxy sealing material is coated on one alignment-processed surface of two assembled substrates. As for another substrate of which both surfaces are alignment-processed, the spacer is dispersed on one surface as mentioned-above. By assembling these three substrates, a cell to form a second liquid crystal layer is obtained. In the same way, all of ten substrates are assembled, and nine cells to form nine liquid crystal layers are obtained.

Next, by heating ten assembled substrates in the oven at 100° C. for one hour, the sealing material is cured. A liquid crystal E63 (manufactured by Merk Japan Inc.) is put into each liquid crystal cell. Last, an electrode is attached to the liquid crystal cell. When a voltage of 30V is applied to the pixel shift device manufactured, an optical axis of incident light is confirmed to be shifted by an optical microscope. This pixel shift device is mounted between a display device (liquid crystal device) and a projection lens of a liquid crystal projector, and driven in synchronization with an image signal of the display device. In this case, operation limit of a liquid crystal director of the pixel shift device is set as 50° and 90°. As a result, a discontinuous pattern (jaggy) clearly displayed on a pixel edge part is almost removed.

(Method 2)

In the pixel shift device manufactured by the method 1, the pixel shift device is driven by shifting a half of timing of response speed for image signal of the display device. As a result, in comparison with the method 1, the jaggy is harder to see, and the image edge part is smoothly displayed. Briefly, by faster signal switch timing of the pixel shift device than display switch timing of the display device, timing of display change of the pixel shift device is confirmed to be more coincided with timing of shift quantity change of the pixel shift device.

(Method 3)

In the same way as the method 1, a pixel shift device having a gap between liquid crystal layers of 7 μm and six layers is manufactured. The pixel shift device is mounted on a projector and driven in operation limit 65° and 90°. As a result, the jaggy is removed, and the pixel edge part is smoothly displayed. Briefly, by setting the gap of liquid crystal layer as 7 μm (not 4.5 μm of the method 1), the response speed falls. However, by narrowing the operation limit of angle θ of the liquid crystal director, sufficient response speed can be obtained.

### COMPARISON EXAMPLE 1

The pixel shift device of the method 3 is operated in operation limit 50° and 90°. In this case, the response speed is insufficient and discontinuity of the pixel edge part is not removed. Briefly, by setting the gap of liquid crystal layer as 7 μm (not 4.5 μm of the method 1), the response speed falls.

(Method 4)

In the pixel shift device of the method 3, in case of switching angle θ of the liquid crystal director from 90° to 50°, a period in which applied voltage is 0V is inserted into a half time of the response speed. As a result, in comparison with non-insertion of 0V (the method 3), the response time is quicker by 20%. When the pixel shift device is mounted onto the projector and driven, the jaggy on the display screen is confirmed to be removed.

(Method 5)

In the same way as the method 1, a pixel shift device having a thickness of liquid crystal of 8.5 μm and five laminated layers is manufactured. ZLI5049 as a liquid crystal material is used. This pixel shift device is mounted onto a DLP projector and driven. The DLP projector in which micro-mirrors of micron size of several hundred thousands are spread all over projects an image onto a screen by reflecting a lamp light from the micro-mirrors.

The DLP projector does not have a polarization. Accordingly, a polarizer is mounted between a DLP device and the pixel shift device so that a liquid crystal director is located perpendicular to a polarized axis of the polarizer. Then, the pixel shift device is operated in synchronization with image signal of the DLP device. As a result, in comparison with non-operation of the pixel shift device, the pixel edge part is smoothly displayed. In this way, even if the display device does not have the polarization, the pixel shift device can be used by adding a polarizer.

(Method 6)

In the method 5, while a dynamic picture is displayed on a projector, a case that a plurality of liquid crystal layers are collectively driven is compared with a case that the shift quantity is gradually changed by respectively driving each liquid crystal layer. In the case that an optical axis is shifted by collectively driving the plurality of liquid crystal layers, noticeable interlace lines occur in the image. Furthermore, in the case that the shift quantity is gradually changed by respectively driving each liquid crystal layer, the interlace lines almost disappear, and the dynamic picture is smoothly displayed.

(Method 7)

In the same way as the method 3, a pixel shift device having a thickness of liquid crystal of 5 μm and four laminated layers is manufactured. In this pixel shift device, thickness of all of liquid crystal layers is half of the pixel shift device of the method 3. This pixel shift device is obliquely mounted onto the display apparatus at an angle of 40°. When a liquid crystal director is operated in angle limit 10°˜90° for a substrate, in the same way as the method 3, the image of high-resolution is displayed.

(Other Methods)

(1) For example, a transparent substrate is not limited to a glass substrate. A plastic substrate or a film substrate may be used. Especially, by using a middle substrate of which both surfaces are alignment-processed as the film substrate, a strong and thin pixel shift device is obtained.

(2) In the pixel shift device, a plurality of liquid crystal cells each manufactured may be laminated. In this case, a matching oil to prevent reflection is set between substrates of laminated cells. As a result, a device of higher transmittance is obtained.

(3) A transparent conductive film of a substrate to be used may be processed by patterning. The transparent conductive film may be formed on an area matched with a size of the display device to be mounted. Furthermore, the transparent conductive film may be formed on an area to display a smooth image.

(4) Furthermore, thickness of each liquid crystal layer to be laminated may not be equal.

(5) As for connection of the electrode, one of top and bottom transparent substrates may be used as a connection terminal by a transfer.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

What is claimed is:

1. A pixel shift device having a liquid crystal structure comprising:
a pair of transparent electrodes;
a pair of alignment films each located on one of the pair of transparent electrodes, one of the pair of alignment films having an anti-parallel alignment to the other of the pair of alignment films; and
a nematic liquid crystal layer between the pair of alignment films.

2. The pixel shift device according to claim 1, further comprising:
a plurality of liquid crystal structures laminated together.

3. The pixel shift device according to claim 1,
wherein an angle of a liquid crystal director of the nematic liquid crystal changes in a limit between 45° and 90° from the alignment direction.

4. The pixel shift device according to claim 1, further comprising:
a driving circuit selectively outputting a first signal and a second signal to the pair of transparent electrodes, the first signal being a first voltage corresponding to a first angle of the liquid crystal director of the nematic liquid crystal layer, and the second signal being a second voltage corresponding to a second angle larger than the first angle.

5. The pixel shift device according to claim 4, wherein
the first angle is above 50° and below 65°, and
the second angle is nearly 90°.

6. The pixel shift device according to claim 4, wherein
the driving circuit outputs a third signal as a third voltage of which absolute value is smaller than the first voltage in case of switching from the second signal to the first signal.

7. The pixel shift device according to claim 1, wherein
a birefringence of a liquid crystal material of the nematic liquid crystal layer is above 0.20.

8. The pixel shift device according to claim 1, wherein
a viscosity parameter of a liquid crystal material of the nematic liquid crystal layer is below 200 mPa·s.

9. A display apparatus comprising:
a display device configured to display an image;
a polarization unit configured to polarize a light outgoing from the display device; and
a pixel shift device configured to shift an optical axis of the polarized light from the polarization unit;
wherein the pixel shift device comprises:
a pair of transparent electrodes;
a pair of alignment films each located on one of the pair of transparent electrodes, one of the pair of alignment films having an anti-parallel alignment to the other of the pair of alignment films in a direction perpendicular to a polarized direction of the polarized light; and
a nematic liquid crystal layer between the pair of alignment films.

10. The display apparatus according to claim 9, further comprising:
a driving circuit selectively outputting a driving signal of the pixel shift device in synchronization with change of an image signal of the display device.

11. The display apparatus according to claim 10, wherein
the driving circuit changes the driving signal at timing shifted from a change timing of the image signal.

12. The display apparatus according to claim 9, wherein
the pixel shift device is obliquely located between 0° and 50° from a direction of the light outgoing from the display device.

13. The pixel shift device according to claim 9, wherein
the pixel shift device further comprises a plurality of liquid crystal structures laminated together.

14. The pixel shift device according to claim 9, wherein
an angle of a liquid crystal director of the nematic liquid crystal changes in a limit between 45° and 90° from the alignment direction.

15. The pixel shift device according to claim 10, wherein
the driving circuit selectively outputs a first signal and a second signal to the pair of transparent electrodes, the first signal being a first voltage corresponding to a first angle of the liquid crystal director of the nematic liquid crystal layer, and the second signal being a second voltage corresponding to a second angle larger than the first angle.

16. The pixel shift device according to claim 15, wherein
the first angle is above 50° and below 65°, and
the second angle is nearly 90°.

17. The pixel shift device according to claim 15, wherein
the driving circuit outputs a third signal as a third voltage of which absolute value is smaller than the first voltage and the second voltage in case of switching from the second signal to the first signal.

18. The pixel shift device according to claim 9, wherein
a birefringence of a liquid crystal material of the nematic liquid crystal layer is above 0.20.

19. The pixel shift device according to claim 9, wherein
a viscosity parameter of a liquid crystal material of the nematic liquid crystal layer is below 200 mPa·s.

20. The pixel shift device according to claim 15, wherein
the driving circuit outputs the first signal at timing earlier than a change timing of the image signal.
